(19) United States
(12) Patent Application Publication
(10) Pub. No.: US 2018/0033216 A1
(43) Pub. Date: Feb. 1, 2018

(54) VEHICLE METER ABLE TO CONNECT WITH AN EXTERNAL APPARATUS

(71) Applicant: AUTO JAW CO., LTD., CHANGHUA COUNTY (TW)

(72) Inventor: Chun-Hsien Chao, Changhua County (TW)

(73) Assignee: AUTO JAW CO., LTD., CHANGHUA COUNTY (TW)

(21) Appl. No.: 15/409,900

(22) Filed: Jan. 19, 2017

(30) Foreign Application Priority Data
Jul. 28, 2016 (TW) 105211400

(51) Int. Cl. G07C 5/00; H04Q 9/00

(52) U.S. Cl. CPC G07C 5/008; H04Q 9/00; H04Q 2209/43

(57) ABSTRACT

A vehicle meter able to connect with an external apparatus includes a main body provided with a control unit and a display unit. The control unit contains a transmission module able to connect with an external apparatus for transmitting data mutually. Thus, by having the external apparatus connected with the vehicle meter, a user can control the function of the vehicle meter to carry out changes of light color or download of vehicle data for carrying out subsequent data analysis or data sharing with other users.

### BACKGROUND OF THE INVENTION

### 1. Field of the Invention

This invention relates to a vehicle meter, particularly to one able to connect with an external apparatus.

### 2. Description of the Prior Art

A current vehicle is usually provided with an engine control unit (ECU in abbreviation), which is connected with various sensors, such as an oil pressure sensor or a water temperature sensor, for monitoring vehicle driving conditions, but data sensed and obtained by the sensors will not necessarily display on the instrument panel of the vehicle; therefore, a user has to set up an external meter by himself for watching data changes of the sensors. Generally speaking, the external meter is first connected with the sensors via a signal line for capturing the data output by the sensors and then, the data are interpreted via built-in interpretation circuit of the external meter and subsequently, the interpreted data are shown on the display of the external meter for users to watch.

Although foresaid conventional external meter enables a user to read the data obtained by the sensors of the vehicle when driving, but the external meter can only let the user read the sensor data of the vehicle in the moment of driving but cannot have the data downloaded and recorded to an external apparatus, such as a cell phone, for the convenience of subsequent data analysis and data sharing with other users. Therefore, the inventor of his invention has observed foresaid drawback and thinks that the conventional external meter is necessary to be ameliorated and hence devises this invention.

### SUMMARY OF THE INVENTION

The objective of this invention is to offer a vehicle meter able to connect with an external apparatus for transmitting data mutually.

The vehicle meter able to connect with an external apparatus in the present invention includes a main body installed at the center console of a vehicle. The main body has its interior formed with an accommodating space and its outer side provided with an opening communicating with the accommodating space. A control unit received in the accommodating space of the main body is electrically connected with a connection module, a processing module and a transmission module. The connection module is electrically connected with the sensor of the vehicle for capturing an original datum produced by the sensor, and the processing module can decode the original datum into a decoded datum, while the transmission module can transmit the decoded datum to an external apparatus and receive a control command transmitted by the external apparatus. A display unit is provided at the location of the opening of the main body and electrically connected with the control unit for receiving and displaying the decoded datum.

The vehicle meter able to connect with an external apparatus of this invention can first capture the original datum and decode the original datum into the decoded datum and then the decoded datum is shown on the display unit for the user to watch the decoded datum of the vehicle in real time and simultaneously, the decoded datum of the vehicle is transmitted to the external apparatus via the transmission module. Thus, after driving the vehicle, the user can glance over the changes of data of the vehicle from the external apparatus for carrying out subsequent data analysis or data sharing with other users.

### BRIEF DESCRIPTION OF DRAWINGS

This invention will be better understood by referring to the accompanying drawings, wherein:

FIG. 1 is an exploded perspective view of a first preferred embodiment of a vehicle meter able to connect with an external apparatus in the present invention;

FIG. 2 is a block diagram of the first preferred embodiment of the vehicle meter able to connect with an external apparatus in the present invention;

FIG. 3 is a schematic view of the first preferred embodiment of the vehicle meter able to connect with an external apparatus in use in the present invention;

FIG. 4 is a schematic view of the first preferred embodiment of the vehicle meter able to connect with an external apparatus in the present invention, showing that the vehicle meter is changed in color; and

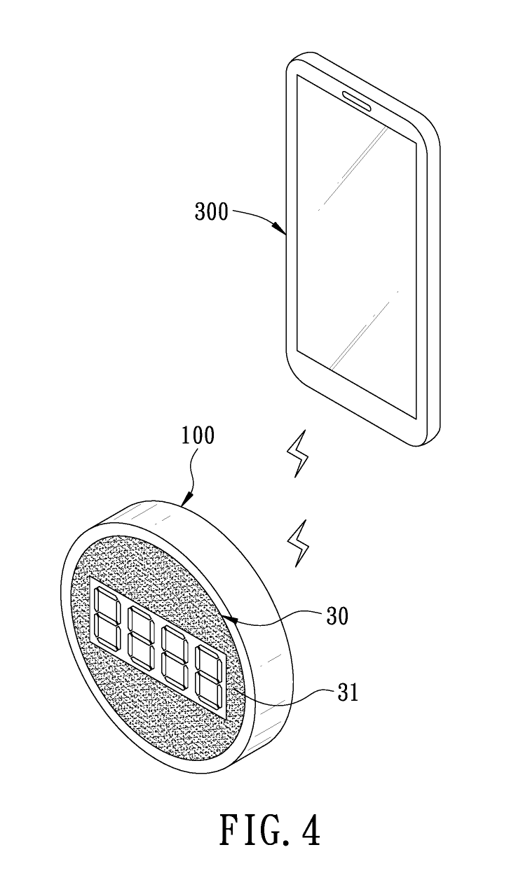

FIG. 5 is a schematic view of a second preferred embodiment of a vehicle meter able to connect with an external apparatus in the present invention;

### DETAILED DESCRIPTION OF THE PREFERRED EMBODIMENT

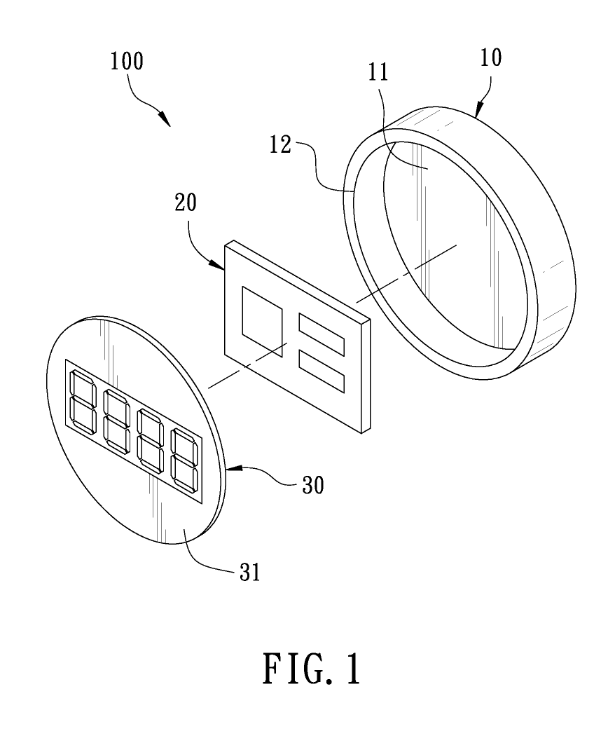

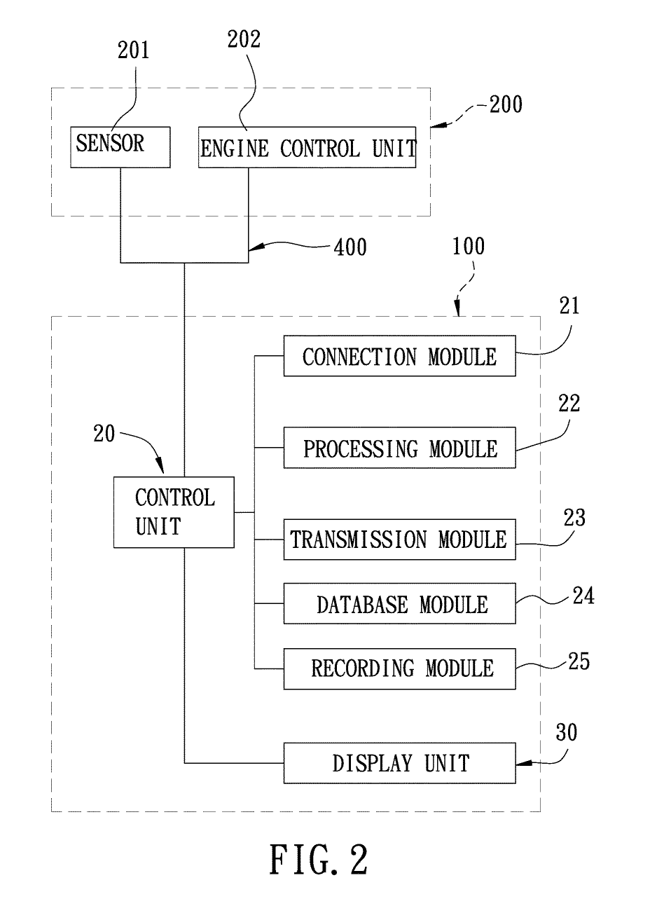

A first preferred embodiment of a vehicle meter 100 able to connect with an external apparatus in the present invention, as show in FIGS. 1 and 2, includes a main body 10, a control unit 20 and a display unit 30 as main components combined together.

The main body 10 installed at the center console of a vehicle 200 has its interior formed with an accommodating space 11 and its outer side provided with an opening 12 communicating with the accommodating space 11.

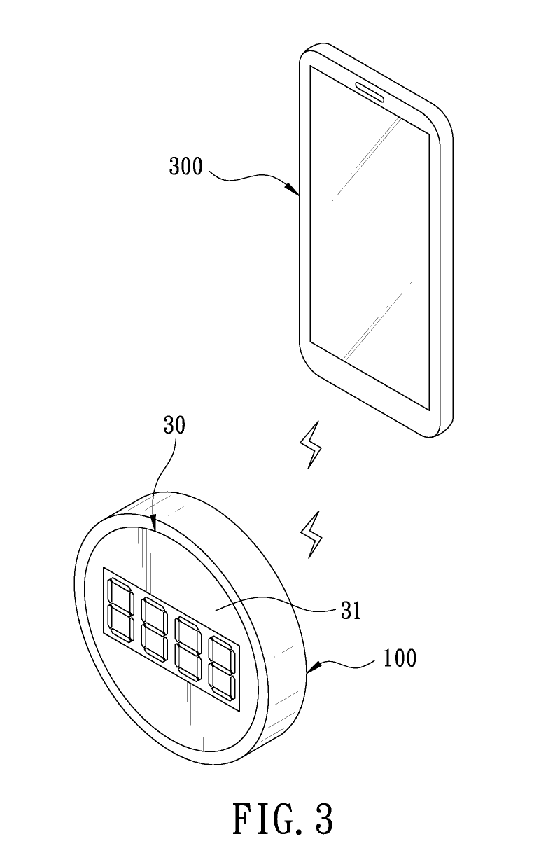

The control unit 20 received in the accommodating space 11 of the main body 10 is electrically connected with a connection module 21, a processing module 22, a transmission module 23, a database module 24 and a recoding module 25. The connection module 21 is electrically connected with the sensor 201 of the vehicle 200 for capturing an original datum produced by the sensor 201. The processing module 22 can decode the original datum into a decoded datum. The transmission module 23 is able to transmit the decoded datum to an external apparatus 300, as shown in FIG. 3 and receive a control command transmitted by the external apparatus 300 and in this preferred embodiment, the transmission module 23 is a Bluetooth device able to connect with the external apparatus 300 by wireless through Bluetooth transfer protocol. The database module 24 has built-in basic information of a plurality of vehicle types, the basic information consisting of a sensor coding comparison table of corresponding vehicle types and color of interior lights of corresponding vehicle types. The recoding module 25 is employed to record the decoded datum.

The display unit 30 is provided at the location of the opening 12 of the main body 10 and electrically connected with the control unit 20 for displaying the data obtained by the control unit 20, and the display unit 30 is provided with a variable color backlight module 31 able to be controlled by the control unit 20 to carry out changes of color.

In use, referring to FIGS. 2 and 3, firstly, have the vehicle meter 100 installed at the center console of the vehicle 200, preferably installed at a location adjacent to the instrument panel of the vehicle 200 for facilitating watching of the vehicle meter 100 and then, have the connection module 21 connected between the sensor 201 and the engine control unit 202 of the vehicle 200 by means of a Y-shaped connecting line 400 for capturing the original datum produced by the sensor 201. At this time, since the data coding modes produced by the sensors of various vehicles are different; therefore, a user must have the transmission module 23 connecting with the external apparatus 300 and have the external apparatus 300 transmitting the control command to the processing module 22 for controlling the processing module 22 to select corresponding vehicle types and obtain the sensor coding comparison table of the corresponding vehicle types from the database module 24. Thus, by making use of a way of data comparison, the processing module 22 can smoothly decode the original datum into the decoded datum and can further have the decoded datum carrying out real-time display via the display module 30 to enable the user to watch and know the real-time condition of the vehicle at present. Simultaneously, the decoded datum can be transmitted to the external apparatus 300 via the transmission module 23 so that, after driving the vehicle 200, the user can glance over the data changes of the vehicle 200 from the external apparatus 300 for carrying out subsequent data analysis and data sharing with other users.

One special feature of this invention is that the recording module 25 can further be employed to record historical data of the decoded data and thus, after driving the vehicle 200, the user can once download all the data in the recording module 25 through the external apparatus 300.

Another special feature of this invention is that the database module 24 is provided therein with built-in data of interior light color of corresponding vehicle types; therefore, when a user makes use of the external apparatus 30 to control the processing module 22 to select corresponding vehicle types, the processing module 22 can also obtain the interior light color of corresponding vehicle types from the database module 24 and control the variable color backlight module 31 of the display module 30 to change color, letting the light color of the vehicle meter 100 become consistent with the interior light color of the vehicle and further letting the vehicle meter 100 harmonize with the color matching of the central console of the vehicle 200 and never appear abrupt.

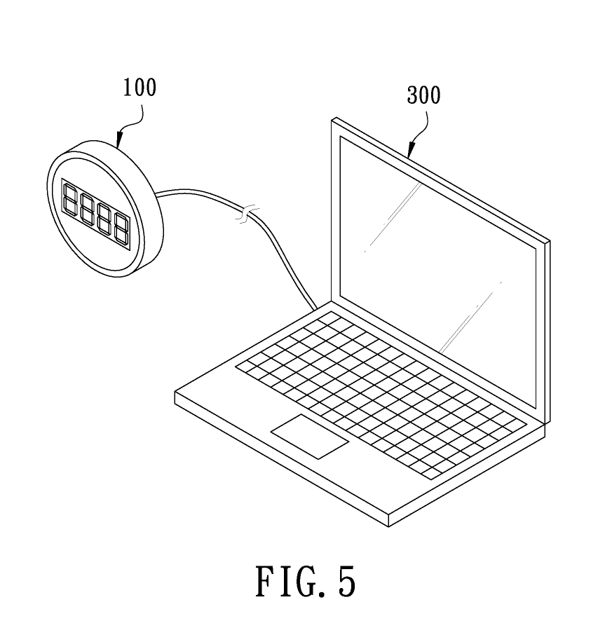

A second preferred embodiment of a vehicle meter 100 able to connect with an external apparatus in the present invention, as shown in FIG. 5, has the same structure as that of the first preferred embodiment, except that the external apparatus 300 is a notebook computer, and the transmission module 23 is a signal terminal able to connect with the external apparatus 300 by a connecting wire, thus attaining the same effect as that of the first preferred embodiment.

While the preferred embodiments of the invention have been described above, it will be recognized and understood that various modifications may be made therein and the appended claims are intended to cover all such modifications that may fall within the spirit and scope of the invention.

What is claimed is:

1. A vehicle meter able to connect with an external apparatus comprising:
a main body provided at the center console of a vehicle, said main body formed with an accommodating space in the interior, said main body having an outer side provided with an opening communicating with said accommodating space;
a control unit received in said accommodating space of said main body, said control unit electrically connected with a connection module and a processing module and a transmission module, said connection module electrically connected with a sensor of said vehicle for capturing an original datum produced by said sensor, said processing module able to decode said original datum into a decoded datum, said transmission module able to transmit said decoded datum to an external apparatus and receive a control demand transmitted by said external apparatus; and
a display unit installed at the location of said opening of said main body, said display unit electrically connected with said control unit, said display unit receiving and displaying said decoded datum.

2. The vehicle meter able to connect with an external apparatus as claimed in claim 1, wherein said connection module is further connected between said sensor of said vehicle and an engine control unit of said vehicle by means of a connecting line for capturing said original datum produced by said sensor.

3. The vehicle meter able to connect with an external apparatus as claimed in claim 1, wherein said control unit is further provided with a database module, said database module provided with built-in basic information of a plurality of vehicle types.

4. The vehicle meter able to connect with an external apparatus as claimed in claim 3, wherein said basic information comprises a sensor coding comparison table of corresponding vehicle types.

5. The vehicle meter able to connect with an external apparatus as claimed in claim 3, wherein said basic information comprises interior light color of corresponding vehicle types.

6. The vehicle meter able to connect with an external apparatus as claimed in claim 1, wherein said control unit has a recording module for recording said decoded datum.

7. The vehicle meter able to connect with an external apparatus as claimed in claim 1, wherein said display unit is provided with a variable color backlight module to be controlled by said control unit for carrying out changes of color.

8. The vehicle meter able to connect with an external apparatus as claimed in claim 1, wherein said transmission module is a Bluetooth device for connecting with said external apparatus by wireless.

9. The vehicle meter able to connect with an external apparatus as claimed in claim 1, wherein said transmission module is a signal terminal for connecting with said external apparatus by a connecting wire.

10. The vehicle meter able to connect with an external apparatus as claimed in claim 1, wherein said external apparatus is a cell phone.
